(19) United States
(12) Patent Application Publication
(10) Pub. No.: US 2015/0245591 A1
(43) Pub. Date: Sep. 3, 2015

(54) Spike bite pet protector

(71) Applicant: Johnny Dwayne Dumas, JR., San Diego, CA (US)

(72) Inventor: Johnny Dwayne Dumas, JR., San Diego, CA (US)

(21) Appl. No.: 13/999,469

(22) Filed: Mar. 3, 2014

(51) Int. Cl. A01K 13/00

(52) U.S. Cl. CPC A01K 13/006

(57) ABSTRACT

The Spike Bite Pet protector is a light weight protective vest worn by your pet with foam pads located in the vulnerable areas of the pets body. The foam pads have a bed of spikes inside them and when an animal attacks the pet the mouth bite from the animal will make contact with the spikes and therefore stops the attack before any serious damage is done to the pet.

New Utility Patent Application/Prior Provisional Application No. 61/851,355

There is no federally sponsored or research or development associated with this application. There is no joint research agreement associated with this application.

### BACKGROUND OF THE INVENTION

(1) Field of the Invention

The spike bite pet protector provides a vest that protects the pet from vicious attacks from other animals.

(2) Description of the Art Including Information Disclosed Under 37 CFR 1.97 & 1.98

The art described in the drawings of the design and utility function illustrate the unique ability of the spike bite pet protector. We found no other patents that are similar nor any products in the market of any similarity.

### BRIEF SUMMARY OF THE INVENTION

The Spike Bite Pet Protector is a very light weight vest that fits around the pet's neck and around the main portion of the body. It has an air flow fabric that has foam padding in the vulnerable areas of the pet's body and inside the foam padding are steel spikes. When another animal attacks the pet and bites into the foam padding the spikes will then be revealed inside the attack animals mouth and stop the attack instantly. The foam is firm enough for the pet owner to hold the pet in their arms and not feel the spikes.

### BRIEF DESCRIPTION OF THE SEVERAL VIEWS OF THE DRAWINGS

There are 4 drawings in total that describe and illustrate the design and function of the spike bite pet protector. In FIG. 1 the broken lines depicting the shape of a dog is not a part of this specification and is only to illustrate the invention around the body of the dog.

FIG. 1: is the front and side angle view of the invention with the broken lines of the dog.

FIG. 2: is the front side angle view of the invention.

FIG. 3: is the side view of the invention.

FIG. 4: is the side view of the spikes inside of the padded foam.

### DETAILED DESCRIPTION OF THE PREFFERED EMBODIMENT

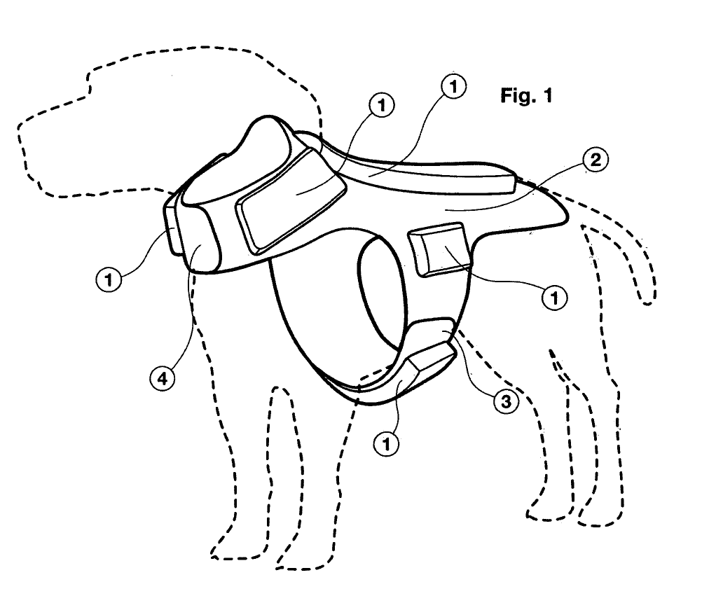

FIG. 1: is the front side angle view of the invention with #1 the foam pads placed on the vulnerable parts of the pet's body with #2 the main body of the invention that can be a solid material or a webbed or netted material for hot weather with #3 the bottom portion with the belt that is held by Velcro in a closed position with #4 the front portion with the belt that is held by Velcro in a closed position illustrating the invention being worn by the dog in broken lines.

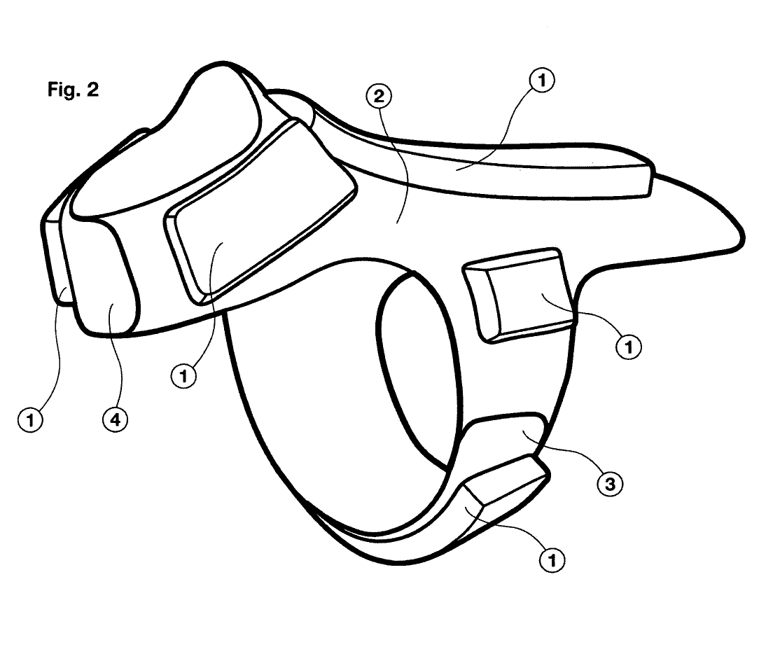

FIG. 2: is the front side angle view of the invention with #1 the foam pads placed on the vulnerable parts of the pet's body with #2 the main body of the invention with #3 the bottom portion with the belt that is held by Velcro in a closed position with #4 the front portion with the belt that is held by Velcro in a closed position.

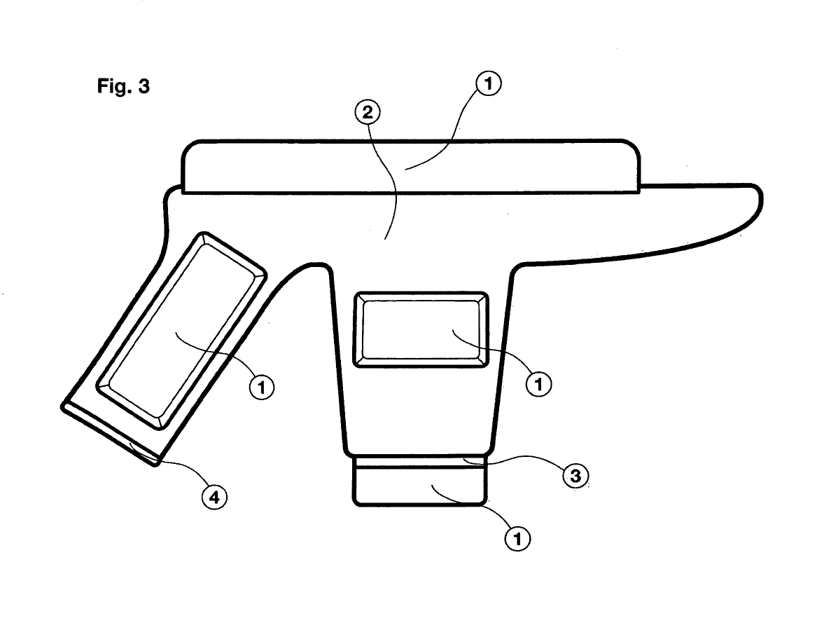

FIG. 3: is the side view of the invention in a closed position with #1 the foam pads placed on the vulnerable areas of the pet's body with #2 the main body of the invention with #3 the bottom belt with #4 the front belt.

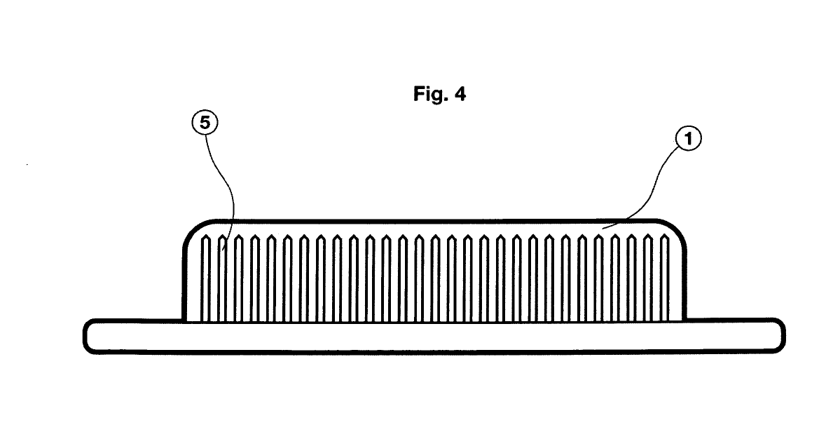

FIG. 4: is the side view of the foam pad showing the interior view of the spikes inside of the padded foam.

### DETAILED DESCRIPTION OF THE INVENTION

The spike bite pet protector is a new concept in protecting your pet from vicious attacks by other animals. There a few types of pet vests that can help protect your pet by using Kevlar material or with a thin metal shield inside. These are good protective devices however they can be too hot for the pet in hot weather. With the Spike Bite it can be made with a netted or webbed main body for hot weather or can be made with a solid main body or can be made for a blanket inside the main body as well. The main effect of the Spike Bite is that it has foam pads that are strategically placed in the vulnerable areas of the pets body such as the neck area, the top, sides, and bottom stomach area of the pets body. The pads are soft but firm enough for any person to pick up their pet and handle the pet without the fear of getting poked by the spikes inside the foam pad. Inside the foam pad is a bed of lightweight spikes that can be made from a lightweight aluminum or a plastic. The spikes are not so sharp that they would pierce the skin of a person handling the pet. The spike comes to a point but not like a needle or the tip of a knife for instance. They come to a blunt point that when an animal is attacking and bits down into the foam pad the mouth of the attacking animal will bite into the spike and it will stop the bite before it can do any damage to the pet wearing the Spike Bite vest. It is an immediate deterrent to an attack from a larger dog or coyote or wolf or possibly hogs, bears, and many other animals that could pose a danger to the pet. Smaller pets are the most vulnerable and because it is so light weight and can be made to be cool in the hot weather and warmer in the cold weather and is a perfect protection device for the appropriate situation. It gives the pet an opportunity to escape or for the owner of the pet to better help the pet. This concept can also be used with human beings with the same type of foam padding with the spikes inside. It is a very versatile invention with many purposes beside the use for a pet. The vest can also act as a flotation device because of the dense foam pads placed throughout the body of the pet. The pads are made of a florescent color for night visibility to better protect the pet.

What is claimed is:

1. The pet protection vest invention having a main body that is comprised of:
a main body that houses the foam pads in the throat area, the top back area, both sides of the body area, and the bottom stomach area;
a webbed or netted configuration for allowing air flow to the pets body while wearing the vest;
a solid material for better protection of the pet and for keeping the pet warmer in cold weather;
a strap located in the throat area and the bottom stomach area with Velcro on each portion of the strap to connect the two pieces together to hold the vest in place while being worn by the pet.

2. The pet protection vest invention with foam pads and spikes inside the pad comprising of:
a firm foam pad that acts as a flotation device for the pet;
a firm foam pad located in the throat area, top back area, both sides of the body, bottom stomach area;
a firm foam pad that has a bed of spikes that come to a blunt point;
a firm foam pad that collapses to expose the spikes inside when an amount of pressure is applied equal to a bite from an animals mouth;
a bed of spikes connected to the bottom portion of the foam pad;
a foam pad that is made of a bright or florescent color for better protection of the pet.
